(19) United States
(12) Patent Application Publication
(10) Pub. No.: US 2002/0080986 A1
(43) Pub. Date: Jun. 27, 2002

(54) Microphone (P507)

(75) Inventors: Alexander Paritsky, Modiin (IL); Alexander Kots, Ashdod (IL); Masahiko Moriguchi, Tottori (JP); Tetsuro Inoue, Tottori (JP); Takumi Matsushima, Tottori (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PHONE-OR, LTD.

(21) Appl. No.: 09/882,772

(22) Filed: Jun. 14, 2001

(30) Foreign Application Priority Data
Oct. 18, 2000 (JP) 11-294905
Oct. 16, 2000 (JP) PCT/JP00/07164

(51) Int. Cl. H04R 9/08; H04R 11/04

(52) U.S. Cl. 381/355

(57) ABSTRACT

A microphone comprising a membrane and a vibration sensing section provided with an air flowing hole independently of the outer periphery of the vibration sensing section. The air flowing hole is conventionally provided continuously from the outer periphery of the vibration sensing section to the inside.

### CROSS-REFERENCES TO RELATED APPLICATIONS

International Publication No.: WO 01/30113

International Application No.: PCT/JP00/07164

International Application Date: Oct. 16, 2000 Oct. 16, 2000

Priority No.: Japanese Patent Application No.11-294905

Priority Date: Oct. 18, 1999 Oct. 18, 1999 JP

### BACKGROUND OF THE INVENTION

1. Technical Field

The microphone of the present invention is applied to a field of small type microphones used for car telephones, mobile phones or the like, and a field of intruder detection utilizing a pressure change due to the intruder.

2. Description of the Related Art

As an oscillatory body of the microphone, a membrane is used. This membrane is stuck with adhesive on the membrane frame that hole are set up in ring-shaped or polygonal. A membrane causes oscillation due to the sound from the outside, the pressure gradation, and so on. The oscillation is detected electrically or optically. Japanese Patent Application 10-107427 discloses an example of a microphone to detect the oscillation optically. In a conventional optical microphone, a space between the membrane and an oscillatory detecting element is set up in about 25 microns to decrease an air resistance. Furthermore, to increase membrane oscillatory amplitude, the oscillatory detecting element is provided with holes that air flowing is possible. The hole is set up by the form that it continued in the inside from the circumference of the oscillatory detecting element, and located to the inside more than a membrane frame inside circle. A microphone output is obtained from pins on the oscillatory detecting element.

There was a problem that microphone output is affected when force is put on the output terminal of the oscillatory detecting element. By the force on the output terminal of the oscillatory detecting element, the oscillatory detecting element is transformed, and a part of the membrane frame gains stress. This stress cause a distortion of the membrane frame and cause the membrane to be loosen or tensioned, and microphone output is affected.

### BRIEF SUMMARY OF THE INVENTION

In this invention, a hole that air flowing is possible is set up independently from the circumference of the oscillatory detecting element.

It becomes the structure that a beam is set up when the hole is set up independently from the circumference of the oscillatory detecting element. In this structure, the amount of oscillatory detecting element deformation by the force on the oscillatory detecting element output terminal is reduced, and the amount of membrane looseness or the amount of tension is reduced, too.

### BRIEF DESCRIPTION OF THE DRAWINGS

FIG. 1 shows an embodiment of a microphone in this invention. In this FIG., 1 is oscillatory detecting element, 2 is output terminal, and 3 is a hole that air flowing is possible.

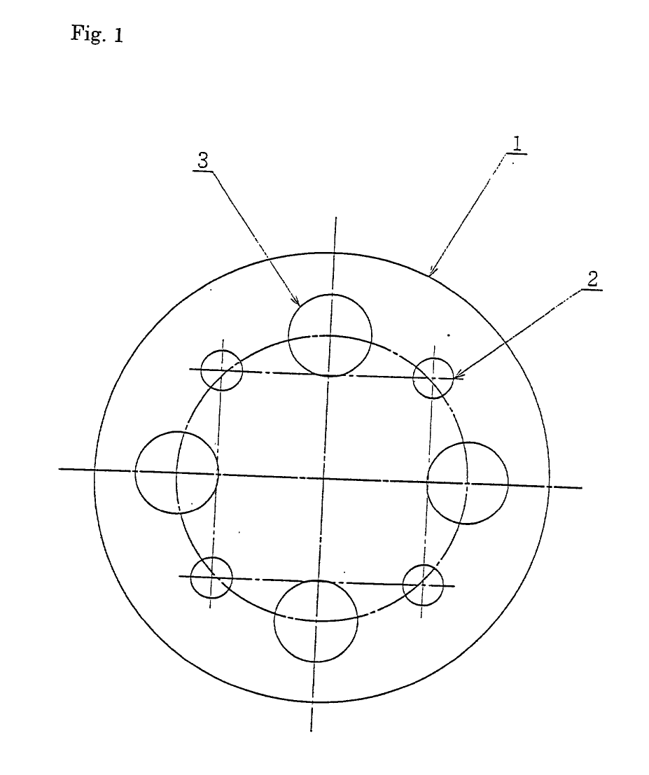

### DESCRIPTION OF THE SPECIFIC EMBODIMENTS

For example, an explanation is made regarding the case where a diameter of an oscillatory detecting element is 5.5 mm. The locations of output terminals are decided in view of suitability with other circuit to be on the vertex of 2.54 mm square. Moreover, oscillatory detection takes a diameter 2.5 mm, and this is done in the center where membrane oscillatory amplitude becomes the biggest. When the hole for air flowing of a diameter 1.0 mm is set up in the location of 1.0 mm from the circumference, the beams of 0.5 mm width in the narrowest part are provided. In these dimensions, the mass production including die processing is easy.

In this invention, the amount of membrane looseness or tension by the force on the oscillatory detecting element pin, and microphone output is less affected.

What is claimed is:

1. A microphone comprising membrane and oscillatory detecting element to detect membrane oscillation,
wherein the oscillatory detecting element has a hole that air flowing is possible, and
wherein the hole that air flowing is possible is provided independently from the oscillatory detecting element.
